(19) United States
(12) Patent Application Publication
(10) Pub. No.: US 2015/0279529 A1
(43) Pub. Date: Oct. 1, 2015

(54) RARE EARTH MAGNET AND METHOD FOR PRODUCING SAME

(71) Applicants: Daisuke Ichigozaki, (US); Noritaka Miyamoto, (US); Tetsuya Shoji, (US); Noritsugu Sakuma, (US); Yuya Ikeda, (US)

(72) Inventors: Daisuke Ichigozaki, Nisshin-shi (JP); Noritaka Miyamoto, Toyota-shi (JP); Tetsuya Shoji, Toyota-shi (JP); Noritsugu Sakuma, Toyota-shi (JP); Yuya Ikeda, Toyota-shi (JP)

(73) Assignee: TOYOTA JIDOSHA KABUSHIKI KAISHA, Toyota-shi, Aichi (JP)

(21) Appl. No.: 14/437,898

(22) PCT Filed: Oct. 8, 2013
(86) PCT No.: PCT/JP2013/077310

§ 371 Date: Apr. 23, 2015

(30) Foreign Application Priority Data
Nov. 2, 2012 (JP) 2012-242528

(51) Int. Cl. H01F 1/057; C22C 30/00; C22C 28/00; C22C 1/04; H01F 41/02; B22F 3/12

(52) U.S. Cl. CPC H01F 1/0576; H01F 41/0266; B22F 3/12; C22C 28/00; C22C 1/04; C22C 30/00

(57) ABSTRACT

A method for manufacturing a rare-earth magnet having excellent workability and coercive-force performance in a high-temperature atmosphere and magnetization performance by controlling the content of Pr as the alloy composition to an optimum range, including: press-forming magnetic powder B to form a compact, the magnetic powder B including a RE-Fe-B main phase MP (RE: Nd and Pr) and an RE-X alloy (X: metal element) grain boundary phase BP around the main phase MP having an average grain size of 10 nm to 200 nm; and performing hot deformation processing to the compact to give magnetic anisotropy thereto, thus manufacturing the rare-earth magnet C that is a nano-crystalline magnet. The content of Nd, B, Co and Pr included in the magnetic powder B is Nd: 25 to 35, B: 0.5 to 1.5 and Co: 2 to 7 in terms of at %, and Pr: 0.2 to 5 at % and Fe.

### TECHNICAL FIELD

The present invention relates to a method for manufacturing a rare-earth magnet that is in the form of an orientational magnet by hot deformation processing.

### BACKGROUND ART

Rare-earth magnets containing rare-earth elements such as lanthanoide are called permanent magnets as well, and are used for motors making up a hard disk and a MRI as well as for driving motors for hybrid vehicles, electric vehicles and the like.

Indexes for magnet performance of such rare-earth magnets include remanence (residual flux density) and a coercive force. Meanwhile, as the amount of heat generated at a motor increases because of the trend to more compact motors and higher current density, rare-earth magnets included in the motors also are required to have improved heat resistance, and one of important research challenges in the relating technical field is how to keep magnetic characteristics of a magnet at high temperatures. For example, in the case of a Nd—Fe—B magnet as one of rare-earth magnets that is used often for vehicle driving motors, attempts are made to increase the coercive force of the magnet by developing finer crystal grains, using an alloy having a composition containing Nd more or adding heavy rare-earth elements such as Dy and Tb having a good coercivity performance, for example.

The following briefly describes one example of the method for manufacturing a rare-earth magnet. For instance, Nd—Fe—B molten metal is solidified rapidly to be fine powder, while pressing-forming the fine powder to be a compact. Hot deformation processing is then performed to this compact to give magnetic anisotropy thereto to prepare a rare-earth magnet (orientational magnet).

The hot deformation processing is performed by placing a compact between upper and lower punches, for example, followed by pressing with the upper and lower punches for a short time while heating for plastic processing.

Researches are progressing day by day for such a method for manufacturing rare-earth magnets to improve their coercive force and degree of magnetization by adding various additive elements, and among them, Pr addition has attracted attention to improve hot deformation workability.

It is known that, however, as the amount of Pr added increases, the coercive force performance of the rare-earth magnet deteriorates in a high-temperature atmosphere. Such deterioration in coercive force in a high-temperature atmosphere results from substitution of Nd in the main phase with Pr, so that it has a Pr—Fe—B composition. It is further known that saturated magnetization also decreases from 1.61(T) for Nd—Fe—B to 1.56(T) for Pr—Fe—B.

For instance, since a driving motor for hybrid vehicle is operated in a high-temperature state of about 150° C. because it is used with high power and high revolution in a compact installation space, a rare-earth magnet built in such a motor has to have a high coercive force in such a high-temperature atmosphere. In order to make such a driving motor for hybrid vehicle compact and have high output therefrom, the magnet has to have high remanence, meaning that a Nd—Fe—B rare-earth magnet has to have high degree of magnetic orientation. Herein, the relationship of remanence=physical value x degree of orientation holds, and so an increase in the degree of orientation by 2 to 3% only can contribute to making the motor compact greatly.

In this way, in order to manufacture a rare-earth magnet having both of high remanence and a high coercive force in a high-temperature atmosphere, it is desired to specify the optimum range of Pr in the alloy composition of a rare-earth magnet.

As conventional techniques relating to a rare-earth magnet having the composition both containing Nd and Pr as the main phase (crystalline) composition that is prepared through hot deformation processing, Patent Literatures 1 to 3 disclose such a rare-earth magnet. These literatures, however, do not describe at all the demonstration result on the optimum content range of Pr to give a rare-earth magnet excellent magnetization performance and coercive-force performance in a high-temperature environment as well as favorable workability during hot deformation processing.

### CITATION LIST

Patent Literatures

Patent Literature 1: JP 2003-229306 A

Patent Literature 2: JP H05-182851 A

Patent Literature 3: JP H11-329810 A

### SUMMARY OF INVENTION

### Technical Problem

In view of the aforementioned problems, the present invention relates to a method for manufacturing a rare-earth magnet through hot deformation processing and a rare-earth magnet manufactured by this method, and aims to provide a rare-earth magnet having excellent workability during the hot deformation processing and having excellent coercive-force performance in a high-temperature atmosphere and magnetization performance by controlling the content of Pr as the alloy composition to be an optimum range, and a method for manufacturing the same.

### Solution to Problem

In order to fulfill the object, a method for manufacturing a rare-earth magnet of the present invention includes: a first step of press-forming magnetic powder as a rare-earth magnetic material to form a compact, the magnetic powder including a RE-Fe-B main phase (RE: Nd and Pr) and an RE-X alloy (X: metal element) grain boundary phase around the main phase, the main phase having an average grain size of 10 nm to 200 nm; and a second step of performing hot deformation processing to the compact to give magnetic anisotropy to the compact, thus manufacturing the rare-earth magnet that is a nano-crystalline magnet. Content of Nd, B, Co and Pr included in the magnetic powder is Nd: 25 to 35, B: 0.5 to 1.5 and Co: 2 to 7 in terms of at %, and Pr: 0.2 to 5 at % and Fe.

According to the conventional knowledge, when a rare-earth magnet that is a nano-crystalline magnet is manufactured through hot deformation processing, Pr contained in the alloy composition of the magnetic powder will give excellent workability during the hot deformation processing, but the rare-earth magnet manufactured will tend to have a decreased coercive force in the high-temperature atmosphere and remanence. On the other hand, the manufacturing method of the present invention can manufacture a rare-earth magnet having high remanence and high coercive-force performance in a high-temperature environment as well as achieving favorable workability during hot deformation processing by controlling the content of Pr in the alloy composition to be an optimum range.

A feature of the present manufacturing method resides in that, in the alloy composition of magnetic powder for magnet used, the content of Pr is adjusted to 0.2 to 5 at %.

When a rare-earth magnet contains a small amount of Pr in the optimum range in its composition, such Pr is concentrated not at the main phase but at the grain boundary phase. This means that such Pr does not affect adversely, such as a decrease in temperature characteristics (remanence) of the main phase. Workability during hot deformation processing greatly depends on the melting point of the grain boundary phase and its composition, but the condensation of such small amount of Pr at the grain boundary phase can make the workability favorable. On the other hand, too much amount of Pr causes such Pr to enter into the main phase to be substituted with Nd in the main phase, thus degrading remanence, and so it is very effective to control the content of Pr to be an optimum range.

The demonstration of the present inventors shows that a rare-earth magnet that is a nano-crystalline magnet manufactured by press-forming magnetic powder for magnet whose content of Pr in the alloy composition is in the range of 0.2 to 5 at % to prepare a compact, and by performing hot deformation processing to the compact can have excellent workability during the hot deformation processing in the manufacturing process, and additionally such a rare-earth magnet has excellent magnetic characteristics of a coercive force at 150° C. that is 5.7 kOe (453 kA/m) or more and of remanence that is 1.38T or higher.

The magnetic powder has the feature of containing Pr in the above-stated range, and specifically, the content of Nd, B, Co and Pr included in the magnetic powder is Nd: 25 to 35, B: 0.5 to 1.5 and Co: 2 to 7 in terms of at %, and Pr: 0.2 to 5 at % and Fe as the remaining (Bal.). The main phase thereof has an average grain size of 10 nm to 200 nm.

At the first step, a melt-spun ribbon (rapidly quenched ribbon) as fine crystal grains is prepared by rapid-quenching of liquid, and the melt-spun ribbon is coarse-ground, for example, to prepare magnetic powder for rare-earth magnet. This magnetic powder is loaded into a die, for example, and is sintered while applying pressure thereto with punches to be a bulk, thus forming an isotropy compact. For the manufacturing of this compact, the magnetic powder having the above composition is used.

In this compound, the RE-X alloy making up the grain phase boundary includes, although this may be different depending on the component of the main phase, when the RE is Nd, an alloy containing Nd and at least one type of Co, Fe, Ga and the like, which may be any one type of Nd—Co, Nd—Fe, Nd—Ga, Nd—Co—Fe, Nd—Co—Fe—Ga, or the mixture of two types or more of them, and a part of Nd is substituted with Pr.

The hot deformation processing at the second step may be performed under conditions of heating in a temperature range of 600 to 850° C., a strain rate in a range of 10⁻³ to 10 (/sec.), and a processing ratio of 50% or more, and the processing is performed for a growth such that the nano-crystalline magnet manufactured has a main phase having an average grain size of 50 nm to 1,000 nm, whereby the resultant has excellent magnetic characteristics as stated above.

Through the hot deformation processing at the second step, a rare-earth magnet that is a nano-crystalline magnet can be manufactured. This rare-earth magnet is an orientational magnet, and in order to improve the coercive force of this orientational magnet more, a modifier alloy including a RE-Y alloy having a eutectic or a RE-rich hyper-eutectic composition (Y: a metal element and not including a heavy rare-earth element) is brought into contact with the rare-earth magnet (orientational magnet) manufactured at the second step, followed by heat treatment at a temperature of the eutectic point of the modifier alloy or higher, thus penetrant-diffusing the melt thereof through a surface of the orientational magnet. Thereby, the melt of the RE-Y alloy is sucked in the grain boundary phase, and a rare-earth magnet with an improved coercive force can be manufactured, while changing the internal structure of the compact. Preferable examples of the modifier alloy having a eutectic or a rare-earth rich hyper-eutectic composition include any one type of a Nd—Cu alloy, a Nd—Al alloy, a Pr—Cu alloy, a Pr—Al alloy, a Nd—Pr—Cu alloy and a Nd—Pr—Al alloy, and among them a Nd—Pr—Cu ternary alloy and a Nd—Pr—Al ternary alloy are preferable. In the case of a Nd—Cu alloy, for example, exemplary compositions of the Nd—Cu alloy having a eutectic or a Nd-rich hyper-eutectic composition include 70at % Nd-30at % Cu, 80at % Nd-20at % Cu, 90at % Nd-10at % Cu and 95at % Nd-5at % Cu. A Nd—Cu alloy has a eutectic point of about 520° C., a Pr—Cu alloy has a eutectic point of about 480° C., a Nd—Al alloy has a eutectic point of about 640° C. and a Pr—Al alloy has a eutectic point of about 650° C., all of which is greatly below 700 to 1,000° C. that causes coarsening of crystal grains making up a nano-crystalline magnet.

The present invention includes a rare-earth magnet as well, and this rare-earth magnet includes a RE-Fe-B main phase (RE: Nd and Pr) and an RE-X alloy (X: metal element) grain boundary phase around the main phase. The main phase has an average grain size in a range of 50 nm to 1,000 nm, content of Nd, B, Co and Pr included in the magnetic powder is Nd: 25 to 35, Pr: 0.2 to 5, B: 0.5 to 1.5 and Co: 2 to 7 and Fe: bal. in terms of at %, and the rare-earth magnet has a coercive force at 150° C. of 5.7 kOe (453 kA/m) or more and remanence of 1.38 T or more.

The rare-earth magnet according to the present invention is a nano-crystalline magnet that contains 0.2 to 5 at % of Pr in the alloy composition making up the magnet, and since this small amount of Pr in the appropriate range is concentrated at the grain boundary phase especially, the magnet can have increased coercive force in the high-temperature atmosphere and remanence. Specifically it has a coercive force at 150° C. of 5.7 kOe (453 kA/m) or more and remanence of 1.38 T or more.

Herein when the remanence is 1.38 T or higher, then the magnetic orientation Mr/Ms (Mr: residual flux density, Ms: Saturated flux density) shows high degree of orientation of 88% or more.

The nano-crystalline magnet has the main phase having the average grain size in the range of 50 nm to 1,000 nm. Herein the “average grain size of the main phase” can be called an average crystalline grain size, which is found by detecting a large number of main phases in a certain area with a TEM image, a SEM image or the like of the magnetic powder and the rare-earth magnet, then measuring the maximum length (long axis) of the main phase on a computer and finding the average of the long axes of the main phases. The main phase of magnetic powder typically has a shape having a large number of corners that is relatively close to a circle in cross section, and the main phase of an orientational magnet subjected to hot deformation processing typically has a shape that is a relatively flattened and horizontally-long ellipse having corners. That is, for the long axis of the main phase of magnetic powder, the longest axis in the polygon is selected on the computer, and for the main phase of the orientational magnet, its long axis is easily specified on the computer, which are then used for calculation of the average grain size.

### Advantageous Effects of Invention

As can be understood from the above description, according to the rare-earth magnet of the present invention and the manufacturing method therefor, the content of Nd, B, Co and Pr included in the magnetic powder is Nd: 25 to 35, B: 0.5 to 1.5 and Co: 2 to 7 in terms of at %, and Pr: 0.2 to 5 at % and Fe, and among them, 0.2 to 5 at % of Pr is contained especially, whereby a rare-earth magnet manufactured can have high remanence and a high coercive force in the high-temperature atmosphere, and have favorable workability for hot deformation processing. In this way, a rare-earth magnet can be manufactured, having excellent workability during hot deformation processing and excellent magnetic characteristics.

### BRIEF DESCRIPTION OF DRAWINGS

FIGS. 1a, b schematically illustrate a first step of a method for manufacturing a rare-earth magnet of the present invention in this order.

FIG. 2 illustrates the micro-structure of a compact that is manufactured by the first step.

FIG. 3 schematically illustrates a second step of the manufacturing method.

FIG. 4 illustrates the micro-structure of a rare-earth magnet (orientational magnet) manufactured.

FIG. 5 illustrates the result of the experiment to specify the relationship between the amount of Pr in the alloy composition of a rare-earth magnet, the coercive force at high temperatures and remanence.

FIG. 6 illustrates a HAADF-STEM image and the result of STEM-EDX (energy-dispersive X-ray spectroscopy).

FIG. 7 illustrates an HAADF-STEM image and the result of the STEM-EDX of the main phase (above) and of the STEM-EDX of the grain boundary phase (below).

### DESCRIPTION OF EMBODIMENTS

The following describes embodiments of a method for manufacturing a rare-earth magnet of the present invention, with reference to the drawings.

(Method for Manufacturing a Rare-Earth Magnet)

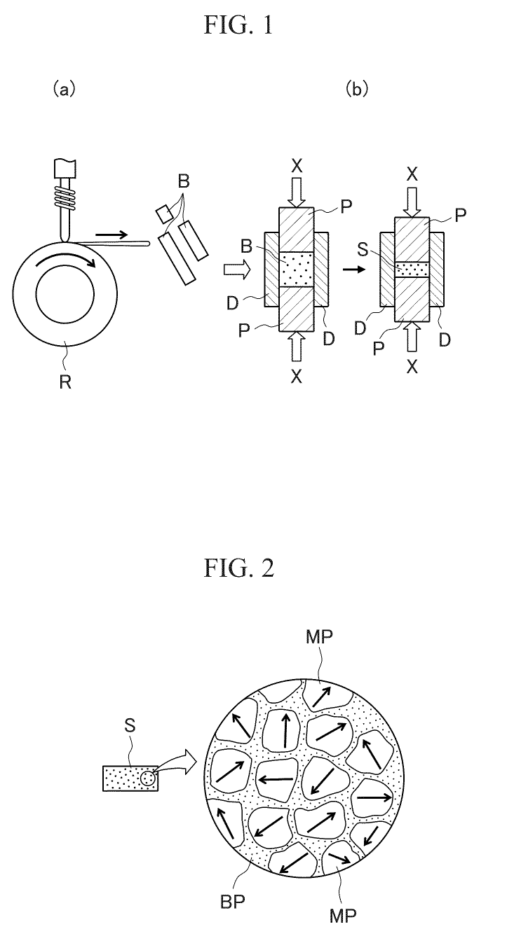

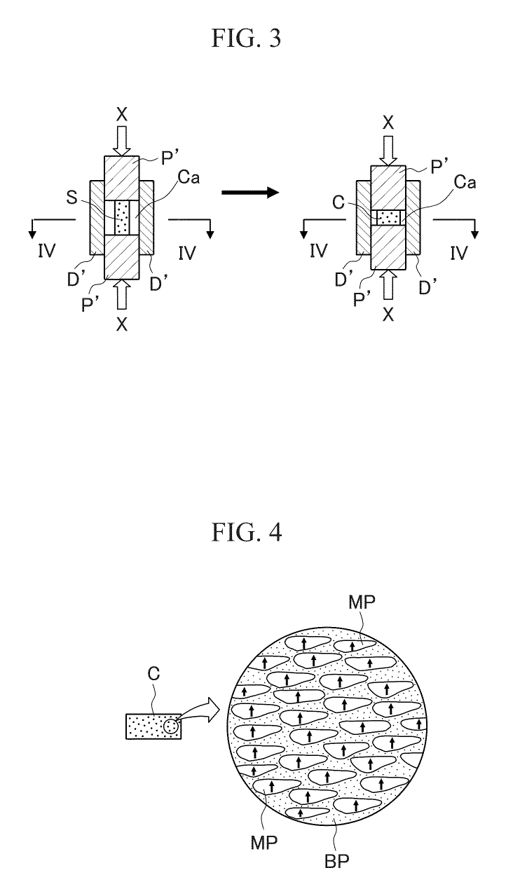

FIGS. 1a, b schematically illustrate a first step of a method for manufacturing a rare-earth magnet of the present invention in this order, and FIG. 2 illustrates the micro-structure of a compact that is manufactured by the first step. FIG. 3 schematically illustrates a second step of the manufacturing method of the present invention.

As illustrated in FIG. 1a, alloy ingot is molten at a high frequency, and a molten composition giving a rare-earth magnet is injected to a copper roll R to manufacture a melt-spun ribbon B by a melt-spun method using a single roll in an oven (not illustrated) under an Ar gas atmosphere at reduced pressure of 50 kPa or lower, for example. The melt-spun ribbon obtained is then coarse-ground.

Among the melt-spun ribbons that are coarse-ground, a melt-spun ribbon B (magnetic powder) having an average grain size of about 10 nm to 200 nm is selected, and this is loaded in a cavity defined by a carbide die D and a carbide punch P sliding along the hollow of the carbide die as illustrated in FIG. 1b. Then, ormic-heating is performed thereto while applying pressure with the carbide punch P (X direction) and letting current flow through in the pressuring direction, whereby a quadrangular-prism shaped compact S is manufactured, including a Nd—Fe—B main phase (having the grain size of about 50 nm to 200 nm) of a nano-crystalline structure and a Nd—X alloy (X: metal element) grain boundary phase around the main phase (first step).

The content of Nd, B, Co and Pr included in the magnetic powder B that is used at the first step is Nd: 25 to 35, B: 0.5 to 1.5 and Co: 2 to 7 in terms of at %, and Pr: 0.2 to 5 at % and Fe (Bal.)

Then the Nd—X alloy making up the grain phase boundary includes an alloy containing Nd and at least one type of Co, Fe, Ga and the like, which may be any one type of Nd—Co, Nd—Fe, Nd—Ga, Nd—Co—Fe, Nd—Co—Fe—Ga, or the mixture of two types or more of them, and a part of Nd is substituted with Pr. Specifically 0.2 to 5 at % of Pr is contained in the grain boundary phase.

As illustrated in FIG. 2, the compact S prepared at the first step shows an isotropic crystalline structure where the space between the nano-crystalline grains MP (main phase) is filled with the grain boundary phase BP.

After preparing the cylindrical-columnar compact S, for example, at the first step, as illustrated in FIG. 3, the compact is then placed in the cavity Ca defined by a carbide die D′ and a carbide punch P′ sliding along the hollow of the carbide die making up a plastic processing mold, and the upper and lower punches P′, P′ are slid at the upper and lower faces of the compact S while bringing the upper and lower punches P′, P′ closer to each other for a short time of 1 sec. or less (pressing in the X direction of FIG. 3) for hot deformation processing. Specifically, the hot deformation processing is performed under the conditions of the heating in the range of 600 to 850° C., the strain rate that is controlled in the range of 10⁻³ to 10 (/sec.), and the processing ratio from the compart S to the rare-earth magnet C of 50% or more.

As a result of this hot deformation processing, a rare-earth magnet C that is an orientational magnet and includes a nano-crystalline magnet is manufactured (second step).

During the hot deformation processing at the second step, the main phase of the compact S having the average grain size of about 10 nm to 200 nm grows in grain size to have the average grain size of 50 nm to 1,000 nm by about five times.

In the present manufacturing method, since 0.2 to 5 at % of Pr is contained in the grain boundary phase of the compact S, the workability during the hot deformation processing is good, and so the crystalline orientation of crystals can be promoted. This crystalline orientation directly relates to remanence of the rare-earth magnet, and the rare-earth magnet C obtained including nano-crystalline magnet has high degree of orientation Mr/Ms (Mr: residual flux density, Ms: saturated flux density) up to 88% or more.

The rare-earth magnet C having the degree of magnetic orientation Mr/Ms of 88% or more has high remanence of 1.38 T or more.

It has a high coercive force as well of 5.7 kOe (453 kA/m) or more in a high-temperature atmosphere at 150° C.

In this way, the magnetic powder for magnet that is used for rare-earth magnet production, and the compact that is shaped by press-forming of this magnetic powder contain 0.2 to 5 at % of Pr in its grain boundary phase, whereby good workability can be ensured during hot deformation processing. This can lead to the rare-earth magnet obtained by the hot deformation processing having high degree of magnetic orientation and remanence, as well as a high coercive force in a high-temperature atmosphere.

[Experiment to Specify the Optimum Range of Pr Amount in Alloy Composition of Rare-Earth Magnet and Result Thereof]

The present inventors conducted an experiment to specify the optimum range of the amount Pr in the alloy composition of rare-earth magnets. In this experiment, a plurality of different types of magnet powder was used to prepare test bodies of rare-earth magnet by the following method, and the magnetic characteristics of these test bodies were measured.

(Method for Preparing Test Bodies)

After preparing Nd—Fe—B powder by rapid quenching with a Cu roll rotating at 3,000 rpm and at the temperature of molten liquid of 1,450° C. (liquid rapid-quenching method), the powder was ground by grinding it in a mortar in an inert atmosphere to be magnetic powder for magnet. This magnetic powder for magnet had the alloy composition of Nd₃₀₋ₓCo₄B₁Prₓ(x: 0, 0.1, 0.2, 0.4, 1, 3.5, 10, 14.9, 29.8)Ga_{0.5}Fe_{Bal.}, and had the main phase with the average grain size of 10 nm to 200 nm.

This magnetic powder was shaped into a compact (bulk) of φ10×15 mm using a carbide die. Table 1 below shows experimental levels for the compacts having different alloy compositions. Each compact was held while being heated at 750° C. with high frequencies, which was compressed by 75% at the ratio of height (15 mm to 3 mm) and at the rate of strain of 1/sec., whereby a rare-earth magnet was produced. Then the center position of the rare-earth magnet produced of 2×2×2 mm was cut out to be a test piece for measurement of magnetic characteristics.

TABLE 1

| | | | | | | | | | Hot deformation | | |
|---|---|---|---|---|---|---|---|---|---|---|---|
| | | | | | | Processing conditions | | | processing conditions | | |
| | Alloy composition of | | | | | for compact | | | | Strain | Processing |
| | magnetic powder (at %) | | | | | Temp. | Pressure | Duration | Temp. | rate | ratio |
| No. | Pr | Nd | Ga | Co | Fe | (° C.) | (MPa) | (min.) | (° C.) | (/sec.) | (%) |
| 0 | 0.0 | 29.8 | 0.5 | 3.9 | Bal. | 650 | 400 | 5 | 750 | 1 | 75 |
| 1 | 0.1 | 29.7 | | | | | | | | | |
| 2 | 0.2 | 29.6 | | | | | | | | | |
| 3 | 0.4 | 29.4 | | | | | | | | | |
| 4 | 0.5 | 29.3 | | | | | | | | | |
| 5 | 0.8 | 29.0 | | | | | | | | | |
| 6 | 1.0 | 28.8 | | | | | | | | | |
| 7 | 3.5 | 26.3 | | | | | | | | | |
| 8 | 10 | 19.8 | | | | | | | | | |
| 9 | 14.9 | 14.9 | | | | | | | | | |
| 10 | 29.8 | 0 | | | | | | | | | |

(Measurement of Magnetic Characteristics and their Evaluation)

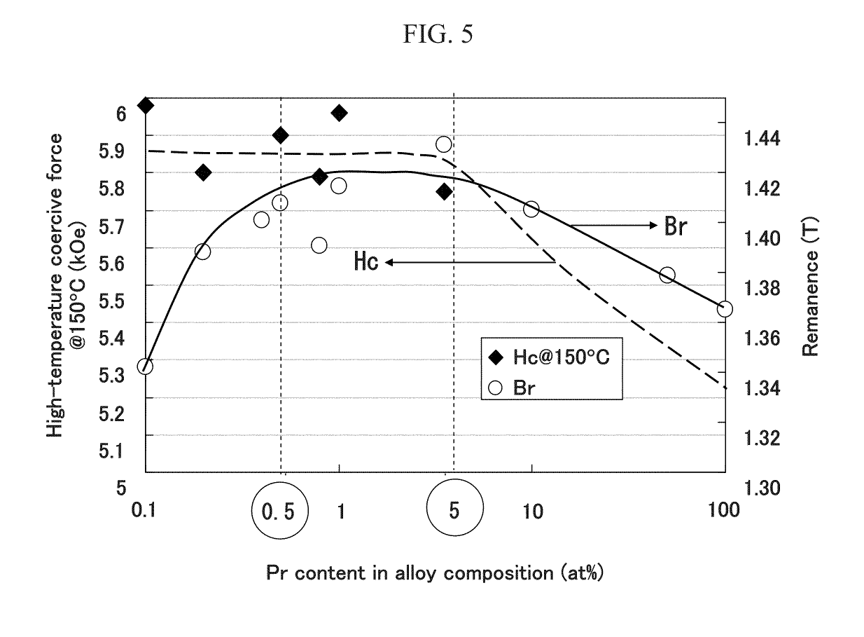

For the evaluations of magnetic characteristics of these test pieces, the coercive force at 50° C. and remanence were measured with a vibrating sample magnetometer (VSM). Then the degree of orientation was measured with a pulsed high field magnetometer (TPM), which was residual flux density/saturated magnetization at 6T. Table 2 below and FIG. 5 show the result of measurements.

TABLE 2

| | | Average | Magnetic | |
|---|---|---|---|---|
| Pr | | coercive | orientation | Coercive force |
| content | Remanence | force | degree | at 150° C. |
| (at %) | Br(T) | Hcj(kOe) | Mr/Ms(%) | (kOe) |
| 0.0 | 1.32 | 12.22 | 87.8 | 6.12 |
| 0.1 | 1.34 | 12.34 | 88.3 | 5.98 |
| 0.2 | 1.39 | 11.34 | 88.8 | 5.8 |
| 0.4 | 1.40 | 11.16 | 89.7 | 6.01 |
| 0.5 | 1.41 | 10.41 | 90.5 | 5.9 |
| 0.8 | 1.39 | 11.39 | 90.9 | 5.79 |
| 1.0 | 1.41 | 11.97 | 91.0 | 5.96 |
| 3.5 | 1.43 | 13.24 | 91.6 | 5.75 |
| 10.0 | 1.41 | 11.67 | 90.5 | 5.23 |
| 14.9 | 1.38 | 12.5 | 90.5 | 4.87 |
| 29.8 | 1.37 | 12.9 | 90.3 | 4.23 |

Note:
For conversion of the unit of coercive force kOe into the International System of Unit (SI) (kA/m), the coercive force was calculated by multiplying it by 79.6.

It was found from Table 2 and FIG. 5 that the coercive force at 150° C. reached an inflection point when the amount of Pr in the alloy composition was 5 at %. The coercive force was around 5.9 kOe below the point, and in the range exceeding 5 at %, the coercive force decreased sharply.

It was found for the remanence that the remanence reached an inflection point when the amount of Pr in the alloy composition was about 0.5 at % and 5 at %. In the range of 0.5 to 5 at %, it showed high remanence of 1.4 T or more, and in both range below and above this range, remanence decreased.

Based on these results, the optimum range of the amount of Pr in the alloy composition of magnetic powder for producing a rare-earth magnet, a compact shaped including this magnetic powder, and the rare-earth magnet produced by hot deformation processing of this compact can be specified as the range of 0.5 to 5 at %.

[Considerations on the Reason why Small Amount of Pr Added Brings the Advantageous Effects]

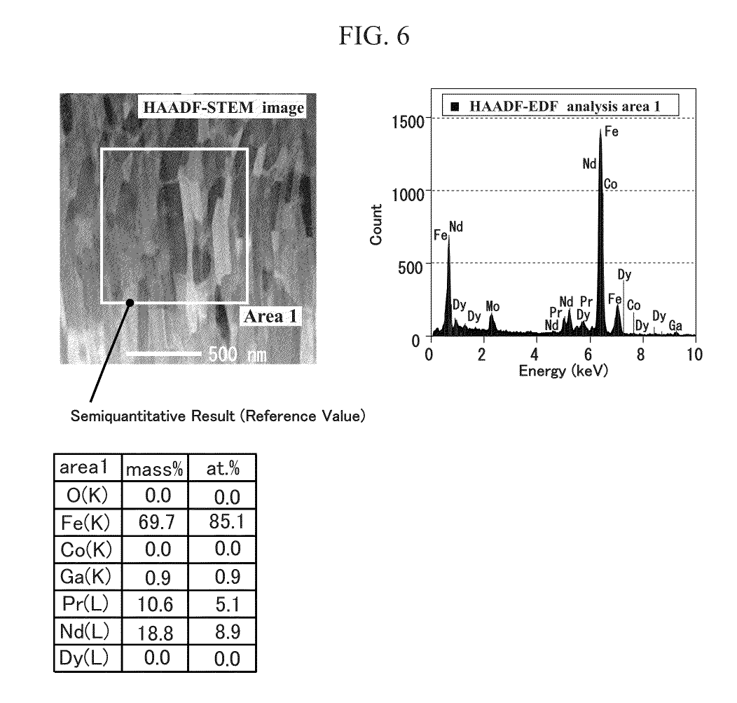

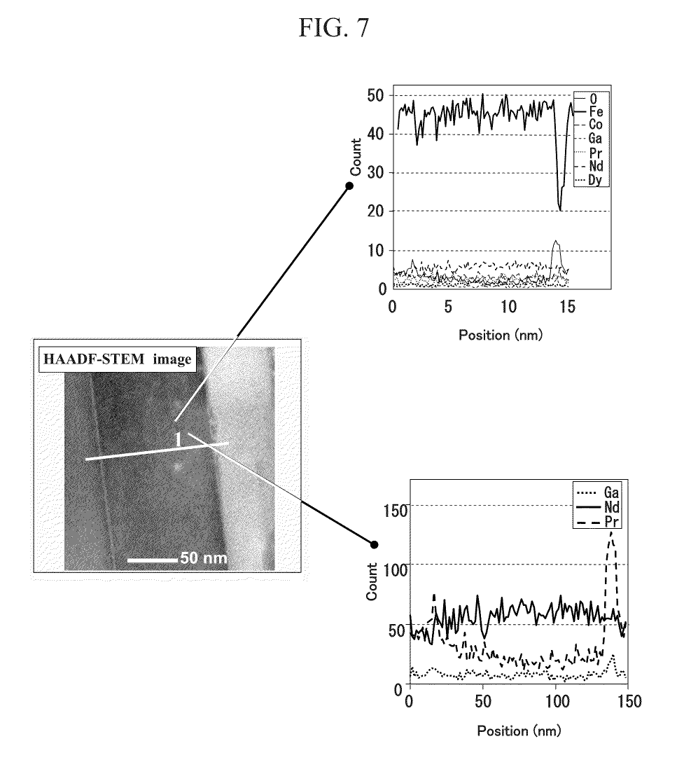

The present inventors further considered the reason why such a small amount of Pr added enabled high degree of orientation (high remanence) without degrading the coercive force. To this end, a HAADF-STEM image of the rare-earth magnet produced was observed, and STEM-EDX (energy-dispersive X-ray spectroscopy) was performed. FIG. 6 illustrates the HAADF-STEM image and the result of the STEM-EDX (energy-dispersive X-ray spectroscopy), and FIG. 7 illustrates the HAADF-STEM image and the result of the STEM-EDX of the main phase (above) and of the STEM-EDX of the grain boundary phase (below).

As illustrated in FIGS. 6 and 7, in a Nd—Fe—B rare-earth magnet containing Nd more than Pr, Pr tends to be deposited selectively at the grain boundary of crystals.

A condition to keep a coercive force at a high temperature is to contain Pr in the amount so as not to cause substitution of Nd in the main phase. In the alloy composition in this analysis, such an amount of the component at the grain boundary phase can be calculated as around 5%, and when Pr exceeding the amount is added, substitution with the main phase occurs and so the coercive force will be degraded in the high-temperature atmosphere. This agrees with the experimental results above.

It is further found that for higher degree of orientation, it is effective to decrease the melting point of the grain boundary phase, and deposition of Pr at the grain boundary phase can lead to the effect of lowering the melting point of the grain boundary phase even when a small amount thereof is added.

Although the embodiments of the present invention have been described in details with reference to the drawings, the specific configuration is not limited to these embodiments, and the design may be modified without departing from the subject matter of the present invention, which falls within the present invention.

### REFERENCE SIGNS LIST

R Copper roll
B Melt-spun ribbon (rapidly quenched ribbon, magnetic powder)
D, D′ Carbide die
P, P′ Carbide punch
S Compact
C Rare-earth magnet (orientational magnet)
MP Main phase (nano-crystalline grains, crystalline grains, crystals)
BP Grain boundary phase

1. A method for manufacturing a rare-earth magnet, comprising:
a first step of press-forming magnetic powder as a rare-earth magnetic material to form a compact, the magnetic powder including a RE-Fe-B main phase (RE: Nd and Pr) and an RE-X alloy (X: metal element) grain boundary phase around the main phase, the main phase having an average grain size of 10 nm to 200 nm; and
a second step of performing hot deformation processing to the compact to give magnetic anisotropy to the compact, thus manufacturing the rare-earth magnet that is a nano-crystalline magnet,
wherein
content of Nd, B, Co and Pr included in the magnetic powder is Nd: 25 to 35, B: 0.5 to 1.5 and Co: 2 to 7 in terms of at %, and Pr: 0.2 to 5 at % and Fe.

2. The method for manufacturing a rare-earth magnet according to claim 1, wherein
the hot deformation processing at the second step is performed under conditions of heating in a temperature range of 600 to 850° C., a strain rate in a range of 10⁻³ to 10 (/sec.), and a processing ratio of 50% or more, and the processing is performed for a growth such that the nano-crystalline magnet manufactured has a main phase having an average grain size of 50 nm to 1,000 nm.

3. A rare-earth magnet including a nano-crystalline magnet, comprising a RE-Fe-B main phase (RE: Nd and Pr) and an RE-X alloy (X: metal element) grain boundary phase around the main phase, wherein
the main phase has an average grain size in a range of 50 nm to 1,000 nm,
content of Nd, B, Co and Pr included in magnetic powder to be the rare-earth magnet is Nd: 25 to 35, Pr: 0.2 to 5, B: 0.5 to 1.5 and Co: 2 to 7 and Fe: bal. in terms of at %, and
the rare-earth magnet has a coercive force at 150° C. of 5.7 kOe (453 kA/m) or more and remanence of 1.38 T or more.
